(19) United States
(12) Patent Application Publication
(10) Pub. No.: US 2001/0033211 A1
(43) Pub. Date: Oct. 25, 2001

(54) Multilayered RF signal transmission circuit and connecting method therein

(76) Inventor: Kuniyoshi Nakada, Tokyo (JP)

Correspondence Address: MCGINN & GIBB, PLLC, 8321 OLD COURTHOUSE ROAD, SUITE 200, VIENNA, VA, 22182-3817, US

(21) Appl. No.: 09/799,351

(22) Filed: Mar. 6, 2001

(30) Foreign Application Priority Data
Apr. 6, 2000 (JP) 110558/2000

(51) Int. Cl. H01P 3/08

(52) U.S. Cl. 333/246; 333/260

(57) ABSTRACT

A multilayered RF signal transmission circuit includes an interlevel via hole comprised of a trunk via hole and a branch via hole. The trunk via hole is formed to pass through a region where a plurality of conductors overlap in a direction perpendicular to planes including them, and to run in a direction perpendicular to a signal transmission direction of the plurality of conductors. The branch via hole runs from each end in a longitudinal direction, along which the trunk via hole runs, of the trunk via hole for a predetermined length substantially symmetrically at a predetermined angle with respect to a direction perpendicular to the longitudinal direction.

### BACKGROUND OF THE INVENTION

1. Field of the Invention

The present invention relates to a multilayered RF signal transmission circuit which electromagnetically couples a plurality of transmission lines present in different layers, thereby transmitting an RF signal, and a connecting method therein.

2. Description of the Prior Art

Conventionally, an electromagnetic coupling slot is used as an interlevel via hole in a multilayered RF signal transmission circuit which transmits a signal with a high frequency in a millimeter-wave range of 30 GHz or more from one microstrip transmission line to another with a small loss.

FIGS. 1, 2A, and 2B schematically show a prior art of the multilayered RF signal transmission circuit.

As shown in the perspective view of FIG. 1, an electromagnetic coupling slot 20 is formed in an RF signal transmission circuit with a two-layer structure which is formed by adhering two dielectric substrates 22a and 22b each having a ground layer (ground plate) 21 on its one surface with each other on the ground layer 21 side, i.e., is formed in the ground layers.

Conductors 23a and 23b are respectively formed on those surfaces of the dielectric substrates 22a and 22b which are opposite to the ground plates 21, thereby forming first and second microstrip transmission lines A and B.

When the conductors 23a and 23b formed on the first and second microstrip transmission lines A and B are electromagnetically coupled to each other through the electromagnetic coupling slot 20, an RF signal can be transmitted from one microstrip transmission line A to the other microstrip transmission line B, and vice versa.

In the RF signal transmission circuit shown in FIGS. 2A and 2B, each of the conductors 23a and 23b terminates into an open stub at one end. These open stubs are electromagnetically coupled to the electromagnetic coupling slot 20, thereby matching the conductors 23a and 23b.

As schematically shown in FIGS. 1, 2A, and 2B, the electromagnetic coupling slot 20 used as a conventional interlevel via hole is formed in a band-like shape.

For example, when the substrate thicknesses are 0.2 mm, the relative dielectric constants of the substrates are 6.0, the characteristic impedances of the conductors are 70 ohm, and the design frequency is 30 GHz, the conductors and the electromagnetic coupling slot are electromagnetically coupled to each other by adjusting a slot length H to 2.0 mm, a slot width W to 0.2 mm, and the open stub length of each conductor (U=B shown in FIGS. 2A and 2B)) to 1.0 mm.

In the electromagnetic coupling slot 20 with the above arrangement, unwanted radiation is large.

Unwanted radiation will be described with reference to FIG. 6A. It can be assumed that a magnetic current is flowing through the electromagnetic coupling slot 20, as shown in FIG. 6A. The magnetic current participates in both electromagnetic coupling of the conductors and unwanted radiation. This will be described in further detail. Near the conductors, that is, near the center in the longitudinal direction of the electromagnetic coupling slot 20, the magnetic current mainly participate in electromagnetic coupling with the conductors. Near the ends of the electromagnetic coupling slot 20, however, the magnetic current causes unwanted radiation. Although the magnetic current at a portion concerning electromagnetic coupling with the conductors and that at portions causing unwanted radiation are separated in FIG. 6A to clarity the description, they cannot be clearly separated in fact.

If too much unwanted radiation is generated, it increases the passing loss of an RF signal in an RF transmission circuit.

The height H of the electromagnetic coupling slot 20 in the prior art described above corresponds to approximately the half wave length of an RF signal passing through the electromagnetic coupling slot 20, and is determined by the substrate conditions and design frequency. It is difficult to further decrease the length H.

### SUMMARY OF THE INVENTION

The present invention has been made in consideration of the above situation in the prior art, and has as its object to provide a multilayered RF signal transmission circuit which can decrease unwanted radiation from an electromagnetic coupling slot, and a connecting method therein.

In order to achieve the above object, according to the first main aspect of the present invention, there is provided a multilayered RF signal transmission circuit for electromagnetically coupling a plurality of conductors respectively formed in different layers formed through ground layers to each other, thereby transmitting an RF signal, comprising an interlevel via hole comprised of a trunk via hole and a branch via hole, the trunk via hole being formed across a region where the plurality of conductors overlap in a direction perpendicular to planes including the plurality of conductors, to run in a direction perpendicular to a signal transmission direction of the plurality of conductors, and the branch via hole running from each end in a longitudinal direction, along which the trunk via hole runs, of the trunk via hole for a predetermined length substantially symmetrically at a predetermined angle with respect to a direction perpendicular to the longitudinal direction.

The above first main aspect has the following several subsidiary aspects.

According to the first subsidiary aspect, the interlevel via hole according to the first main aspect is formed in the ground layers formed between layers; of the plurality of conductors respectively formed in the different layers.

According to the second subsidiary aspect, the branch via hole according to the first main aspect is formed at an angle of 90 degrees with respect to the longitudinal direction of the trunk via hole.

According to the third subsidiary aspect, a dielectric substrate is formed between the plurality of conductors respectively formed in the different layers and the ground layers formed between the different layers according to the first subsidiary aspect.

According to the fourth subsidiary aspect, each one of the plurality of conductors according to the first main aspect has one end that forms an open stub and/or short stub.

According to the second main aspect of the present invention, there is provided a connecting method in a multilayered RF signal transmission circuit, of electromagnetically coupling a plurality of conductors respectively formed in different layers formed through ground layers to each other, thereby transmitting an RF signal, the method comprising electromagnetically coupling the plurality of conductors through an interlevel via hole comprised of a trunk via hole and a branch via hole, the trunk via hole being formed to pass through a region where the plurality of conductors overlap in a direction perpendicular to planes including the plurality of conductors, and to run in a direction perpendicular to a signal transmission direction of the plurality of conductors, and the branch via hole running from each end in a longitudinal direction, along which the trunk via hole runs, of the trunk via hole for a predetermined length substantially symmetrically at a predetermined angle with respect to a direction perpendicular to the longitudinal direction, thereby transmitting the RF signal.

As is apparent from the above aspect, according to the present invention, unwanted radiation from the interlevel via hole is decreased, so that passing loss of the RF signal can be decreased.

According to the present invention, the trunk via hole of the interlevel via hole can be made shorter than that of a conventional one, greatly contributing to downsizing of the RF signal transmission circuit.

The other and many objects, features and advantages of the present invention will become manifest to those skilled in the art upon making reference to the following detailed description and accompanying drawings in which preferred embodiments incorporating the principle of the present invention are shown by way of illustrative examples.

### BRIEF DESCRIPTION OF THE DRAWINGS

FIG. 1 is a perspective view schematically showing an arrangement of a conventional multilayered RF signal transmission circuit;

FIGS. 2A and 2B are plan and longitudinal sectional views, respectively, of the multilayered RF signal transmission circuit shown in FIG. 1;

FIG. 3 is a perspective view schematically showing an arrangement of a multilayered RF signal transmission circuit according to the first embodiment of the present invention;

FIGS. 4A and 4B are plan and longitudinal sectional views, respectively, of the multilayered RF signal transmission circuit shown in FIG. 3;

FIG. 5 is a plan view showing the shape of the electromagnetic coupling slot of the embodiment shown in FIG. 3;

FIGS. 6A to 6C are views for explaining unwanted radiation;

FIG. 7 is a table showing the relationship between the length of the electromagnetic coupling slot and unwanted radiation;

FIGS. 8A to 8D are plan views respectively showing the shapes of other electromagnetic coupling slots;

FIGS. 9A and 9B are plan and longitudinal sectional views, respectively, of a multilayered RF signal transmission circuit according to the second embodiment of the present invention;

FIGS. 10A and 10B are plan and longitudinal sectional views, respectively, of a multilayered RF signal transmission circuit according to the third embodiment of the present invention;

FIGS. 11A and 11B are plan and longitudinal sectional views, respectively, of a multilayered RF signal transmission circuit according to the fourth embodiment of the present invention; and

FIGS. 12A and 12B are plan and longitudinal sectional views, respectively, of a multilayered RF signal transmission circuit according to the fifth embodiment of the present invention.

### DETAILED DESCRIPTION OF PREFERRED EMBODIMENTS

Several preferred embodiments of the present invention will be described with reference to the accompanying drawings.

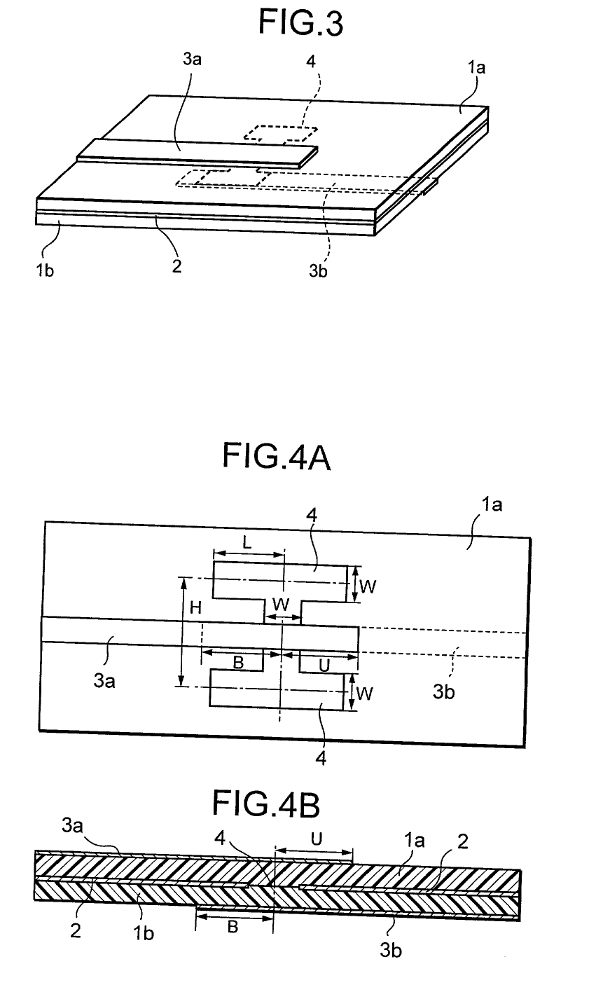

FIG. 3 to FIGS. 12A and 12B show a multilayered RF signal transmission circuit and a connecting method therein according to several preferred embodiments of the present invention.

The first embodiment of the present invention will be described in detail with reference to FIGS. 3, 4A, and 4B. As shown in FIGS. 3, 4A, and 4B, a multilayered RF signal transmission circuit according to the first embodiment has two dielectric substrates 1a and 1b each having one surface formed with a ground plate 2 serving as a ground layer and the other surface formed with a conductor 3a or 3b. The two dielectric substrates 1a and 1b are adhered to each other with their surfaces having the ground plates 2, so as to form first and second microstrip transmission lines A and B. An electromagnetic coupling slot (interlevel via hole) 4 is formed in the ground plates 2 sandwiched by the two dielectric substrates 1a and 1b.

The multilayered RF signal transmission circuit according to the first embodiment of the present invention has the arrangement as described above.

In the two-layer RF signal transmission circuit with the above arrangement, the upper and lower conductors 3a and 3b in FIGS. 4A and 4B, respectively formed on the dielectric substrates 1a and 1b are electromagnetically coupled to each other through the electromagnetic coupling slot 4, so that an RF signal can be transmitted from the first microstrip transmission line A to the second microstrip transmission line B, and vice versa. Each of the two conductors 3a and 3b has one end that forms an open stub. These open stubs are electromagnetically coupled to the electromagnetic coupling slot 4, thereby matching the conductors 3a and 3b.

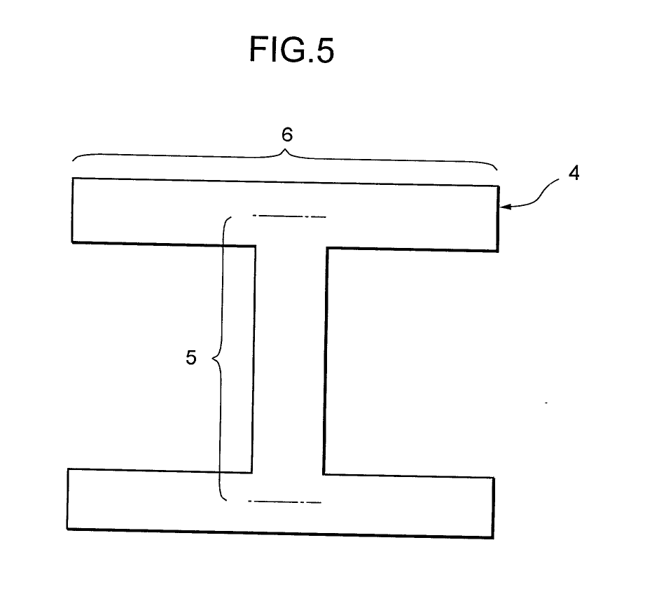

The electromagnetic coupling slot 4 according to the first embodiment is formed in an H shape on a plane having a trunk via hole 5 and branch via holes 6, as shown in FIG. 5. The branch via holes 6 branch from the two ends in the longitudinal direction of the trunk via hole 5 symmetrically at a predetermined angle (approximately 90 degrees in the example shown in FIG. 5) with respect to the longitudinal direction, and run for predetermined lengths.

The reason the planar outer shape of the electromagnetic coupling slot 4 is formed in this manner will be described.

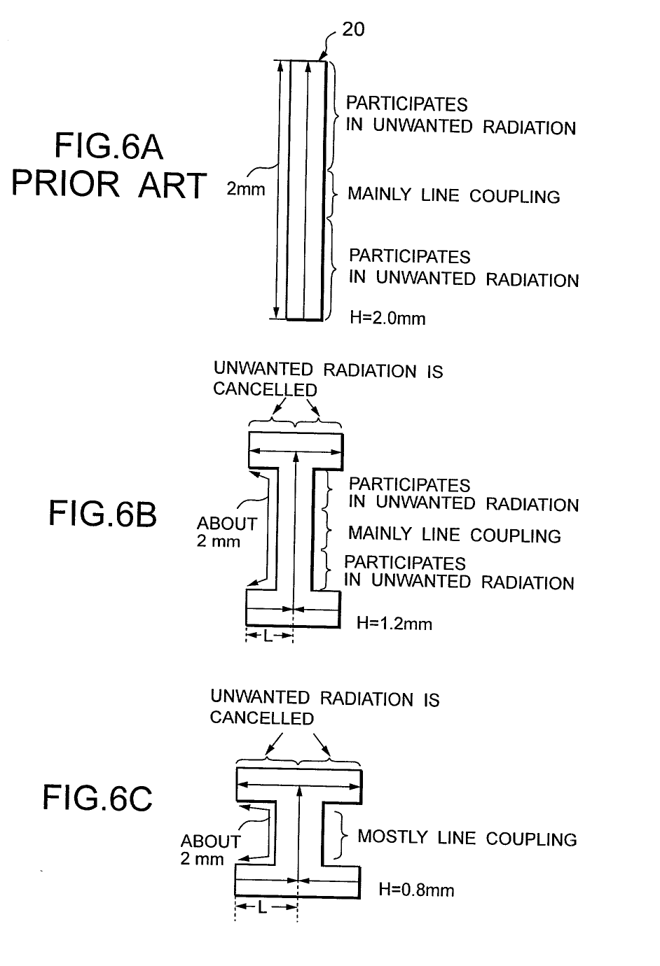

It can be assumed that a magnetic current is flowing through the electromagnetic coupling slot 4, as shown in FIGS. 6A to 6C. The magnetic current concerns both electromagnetic coupling of the conductors 3a and 3b and unwanted radiation. In the following description, the substrate thickness is 0.2 mm, the relative dielectric constant of the dielectric substrate is 6.0, the characteristic impedance of the transmission line is 70 ohm, and the design frequency is 30 GHz.

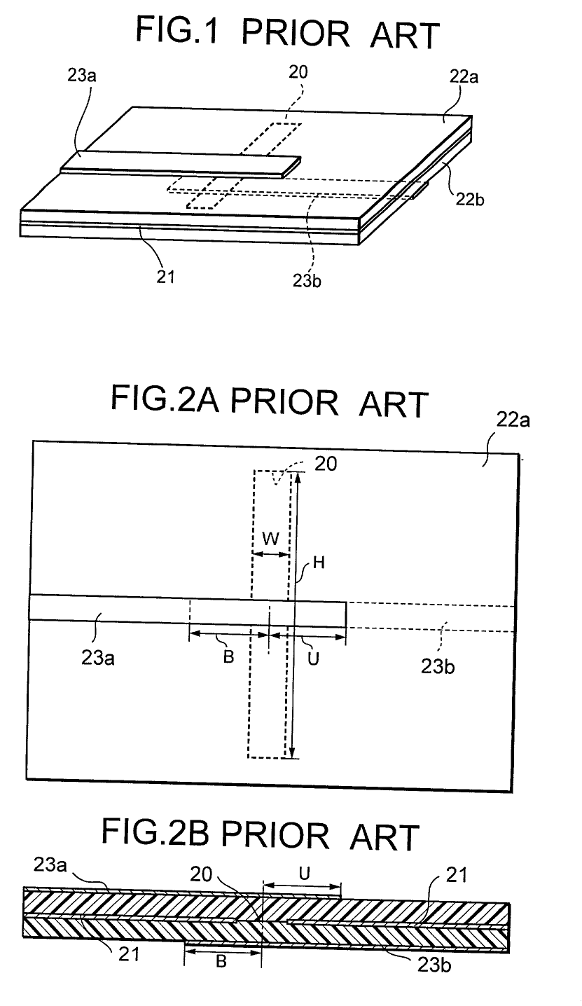

With the above conditions, the electromagnetic coupling slot 4 and conductors 3a and 3b are electromagnetically coupled to each other by setting the length of the magnetic current to 2.0 mm and the open stub length (U=B shown in FIG. 1) to 1.0 mm.

As shown in FIGS. 6A to 6C, the magnetic current near the conductors 3a and 3b, that is, near the center of the electromagnetic coupling slot 4 or 20 mainly participates in electromagnetic coupling with the conductors 3a and 3b. However, the magnetic current at the ends of the electromagnetic coupling slot 4 mainly causes unwanted radiation. In the conventional electromagnetic coupling slot 20 shown in FIG. 6A, the magnetic currents at its two ends cause unwanted radiation. Unwanted radiation can lead to a passing loss of an RF signal.

In contrast to this, according to the first embodiment, the branch via holes 6 are formed at the two ends in the longitudinal direction of the trunk via hole 5 to branch in directions perpendicular to the longitudinal direction, as shown in FIG. 6B or 6C. Therefore, as shown in FIG. 6B or 6C, the magnetic current also branches into the right and left branch via holes 6. At this time, since the directions of the magnetic currents in the respective branch via holes 6 are opposite to each other, they cancel radiation caused by the magnetic currents, thereby decreasing unwanted radiation. As a result, the amount of passing loss of the RF signal between the microstrip transmission lines can be decreased.

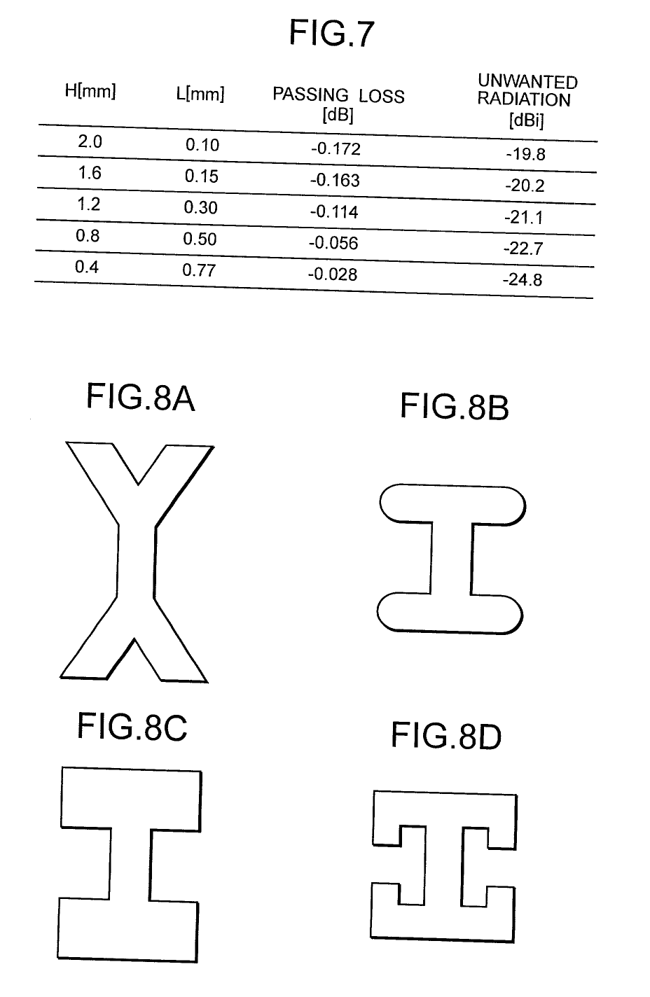

FIG. 7 shows the relationship between the amount of passing loss of an RF signal between the microstrip transmission lines and the unwanted radiation level when electromagnetic coupling of the conductors 3a and 3b and electromagnetic coupling slot 4 is optimized by using the length H of the trunk via hole 5 of the electromagnetic coupling slot 4 as a parameter. The thicknesses of the dielectric substrates 1a and 1b, the relative dielectric constants of the substrates, the characteristic impedances of the conductors 3a and 3b, the design frequency, and the like are identical to those of the conditions described above, while fixing a width W of the electromagnetic coupling slot 4 to 0.2 mm. A length H=2.0 mm of the trunk via hole 5 of the electromagnetic coupling slot 4 is equal to the length of the conventional electromagnetic coupling slot.

As shown in FIG. 7, as the length H of the trunk via hole 5 of the electromagnetic coupling slot 4 is decreased, the amount of passing loss and the unwanted radiation level can be decreased. As shown in FIG. 7, when the length H of the trunk via hole 5 of the electromagnetic coupling slot 4 is decreased, a length L, shown in FIG. 4B or 4C, from the end in the longitudinal direction to near the center of the branch via holes 6 of the electromagnetic coupling slot 4 must be increased. As the length L is a dimension in direction along the conductors 3a and 3b, even if L is large, it does not interfere with downsizing of the electromagnetic coupling slot 4. Accordingly, although L increases when H is decreased, the electromagnetic coupling slot 4 as a whole can be downsized.

The shape of the electromagnetic coupling slot 4 is not limited to that shown in FIGS. 4A and 4B, 5, 6B or 6C, and modifications as shown in FIGS. 8A to 8D are possible. More specifically, branch via holes 6 need not be perpendicular to the longitudinal direction of the trunk via hole 5, but may be formed at a predetermined angle with respect to the longitudinal direction of the trunk via hole 5, as shown in FIG. 8A. The two ends of branch via holes 6 may be round, as shown in FIG. 8B. The slot width of a trunk via hole 5 and those of branch via holes 6 may be changed, as shown in FIG. 8C. Alternatively, the ends of branch via holes 6 may be parallel to the longitudinal direction of a trunk via hole 5, as shown in FIG. 8D.

The embodiments and modifications described above are preferable embodiments and modifications of the present invention. The present invention, however, is not limited to them, and other embodiments and various modifications may be made within a scope not departing from the spirit of the present invention.

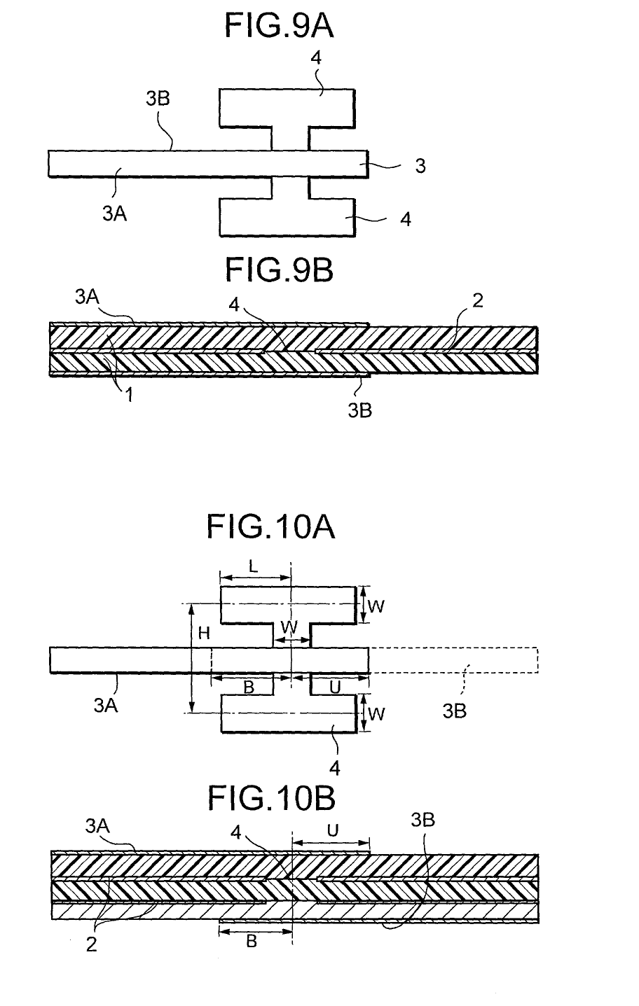

For example, the arrangement of the multilayered RF signal transmission circuit where the electromagnetic coupling slot 4 is to be formed is not limited to that shown in FIGS. 4A and 4B. As shown in FIGS. 9A and 9B, an upper microstrip transmission line and lower microstrip transmission line transmit may transmit signals in opposite directions. In this case, the sizes of the respective portions of an electromagnetic coupling slot 4 and sizes of the stubs of conductors 3a and 3b are not much different from those of the first embodiment shown in FIGS. 4A and 4B.

The first embodiment shown in FIGS. 4A and 4B is comprised of the two dielectric substrates 1a and 1B. Alternatively, as shown in FIGS. 10A and 10B, even when two ground plates are formed among three dielectric substrates, if electromagnetic coupling slots 4 are formed in the respective ground plates, an RF signal can be transmitted through the three dielectric substrates.

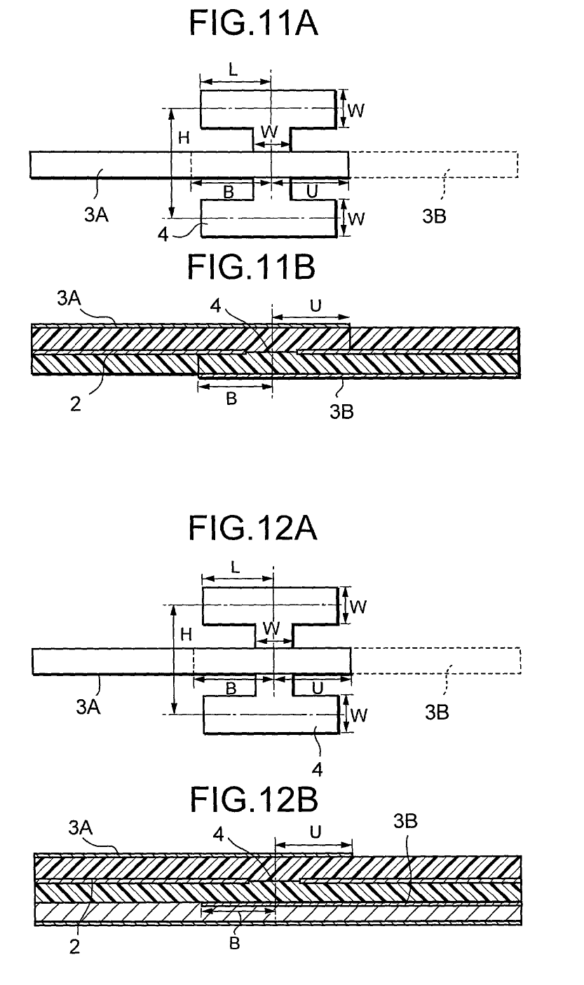

In the first embodiment shown in FIGS. 4A and 4B, each of the conductors 3a and 3b has one end that forms an open stub. Alternatively, as shown in FIGS. 11A and 11B, this portion can form a short stub. In this case, the stub length is different from that of the open stub. In FIGS. 11A and 11B, an upper conductor 3a may have an open stub, while a lower conductor 3b may have a short stub, or vice versa.

In the embodiments described above, the present invention is applied to microstrip transmission lines. The present invention can naturally be applied to other transmission lines, i.e., a coplanar transmission line, or a triplate transmission line shown in FIGS. 12A and 12B.

What is claimed is:

1. A multilayered RF signal transmission circuit for electromagnetically coupling a plurality of conductors respectively formed in different layers formed through ground layers to each other, thereby transmitting an RF signal, comprising an interlevel via hole comprised of a trunk via hole and a branch via hole, said trunk via hole being formed to pass through a region where said plurality of conductors overlap in a direction perpendicular to planes including said plurality of conductors, and to run in a direction perpendicular to a signal transmission direction of said plurality of conductors, and said branch via hole running from each end in a longitudinal direction, along which said trunk via hole runs, of said trunk via hole for a predetermined length substantially symmetrically at a predetermined angle with respect to a direction perpendicular to said longitudinal direction.

2. A circuit according to claim 1, wherein said interlevel via hole is formed in said ground layers formed between layers of said plurality of conductors respectively formed in said different layers.

3. A circuit according to claim 1, wherein said branch via hole of said interlevel via hole is formed at an angle of 90 degrees with respect to said longitudinal direction of said trunk via hole.

4. A circuit according to claim 2, wherein said branch via hole of said interlevel via hole is formed at an angle of 90 degrees with respect to said longitudinal direction of said trunk via hole.

5. A circuit according to claim 2, further comprising a dielectric substrate between said plurality of conductors respectively formed in said different layers and said ground layers formed between said different layers.

6. A circuit according to claim 1, wherein each one of said plurality of conductors has one end that forms an open stub and/or short stub.

7. A circuit according to claim 2, wherein each one of said plurality of conductors has one end that forms an open stub and/or short stub.

8. A circuit according to claim 3, wherein each one of said plurality of conductors has one end that forms an open stub and/or short stub.

9. A circuit according to claim 4, wherein each one of said plurality of conductors has one end that forms an open stub and/or short stub.

10. A circuit according to claim 5, wherein each one of said plurality of conductors has one end that forms an open stub and/or short stub.

11. A connecting method in a multilayered RF signal transmission circuit, of electromagnetically coupling a plurality of conductors respectively formed in different layers formed through ground layers to each other, thereby transmitting an RF signal, said method comprising electromagnetically coupling said plurality of conductors through an interlevel via hole comprised of a trunk via hole and a branch via hole, said trunk via hole being formed to pass through a region where said plurality of conductors overlap in a direction perpendicular to planes including said plurality of conductors, and to run in a direction perpendicular to a signal transmission direction of said plurality of conductors, and said branch via hole running from each end in a longitudinal direction, along which said trunk via hole runs, of said trunk via hole for a predetermined length substantially symmetrically at a predetermined angle with respect to a direction perpendicular to said longitudinal direction, thereby transmitting the RF signal.
